(19) United States
(12) Patent Application Publication
(10) Pub. No.: US 2009/0050715 A1
(43) Pub. Date: Feb. 26, 2009

(54) DISPENSING APPARATUS

(75) Inventor: Mark Anthony Ian Gidlow, Nottingham (GB)

Correspondence Address: NIXON PEABODY LLP - PATENT GROUP, 1100 CLINTON SQUARE, ROCHESTER, NY, 14604, US

(73) Assignee: PLASTICUM UK LIMITED, Alfreton, Derbyshire (GB)

(21) Appl. No.: 11/570,487

(22) PCT Filed: Jun. 10, 2005
(86) PCT No.: PCT/GB05/02299

§ 371 Date: Dec. 12, 2006

(30) Foreign Application Priority Data
Jun. 12, 2004 (GB) 0413164.5

(51) Int. Cl. B05B 1/34

(52) U.S. Cl. 239/490

(57) ABSTRACT

Apparatus is disclosed for dispensing a liquid product in the form of a spray. The apparatus comprises a dispensing conduit having an inlet portion (24, 124) terminating at a target surface (26, 126) with which, in use, the liquid product collides, and an outlet portion (28, 128) extending from an entrance aperture in the target surface (26, 126) to an exit aperture from which the liquid product emerges as a spray. The target surface (26, 126) has at least one channel (27, 127) that causes a turbulent flow of the liquid product, in use, into the outlet portion (28, 128) of the dispensing conduit.

This invention relates to dispensing apparatus, and in particular to apparatus for dispensing liquid products in the form of a spray.

Many liquid products are packaged in containers that include means for dispensing the liquid product in the form of a spray. Such containers typically dispense the liquid product, under pressure, through a dispensing valve. For example, the liquid product may be stored under pressure in a sealed container fitted with a dispensing valve. Alternatively, the liquid product may be stored in a container fitted with a dispensing valve that includes pump means for urging the liquid product though the dispensing valve under pressure.

In any case, however, some form of actuator is usually fitted to the container, often as a cap. The actuator includes means for operating the dispensing valve and any associated pump means, and an outlet through which the product is dispensed as a spray. Conventional actuators generally comprise a conduit leading to an outlet, the conduit being in fluid communication with the dispensing valve. Generally, the user depresses the actuator to actuate the valve and any associated pump means, and hence dispense the product through the outlet of the actuator in the form of a spray.

It is very often desirable to form a spray comprising a fine mist of liquid droplets. Conventionally, therefore, dispensing apparatus includes means for atomising the liquid product into small droplets before it is dispensed as a spray. A preferred method of atomising the liquid product is by means of a flow-modifying insert that is fitted within the outlet of the actuator during manufacture. In use, the liquid product flows through the flow-modifying insert before exiting the outlet of the actuator as a spray. Typically, flow-modifying inserts act to form a vortex within the liquid product, which causes atomisation of the liquid product and forms a spray comprising a fine mist of liquid droplets.

However, since the flow-modifying insert is generally of relatively complex structure, actuator caps including such flow-modifying inserts are conventionally manufactured as two components that are then assembled together on an assembly line. The presence of a flow-modifying insert therefore increases the cost of manufacture significantly.

There has now been devised improved dispensing apparatus which overcomes or substantially mitigates the above-mentioned and/or other disadvantages associated with the prior art.

According to the invention, there is provided apparatus for dispensing a liquid product in the form of a spray, said apparatus comprising a dispensing conduit having an inlet portion terminating at a target surface with which, in use, the liquid product collides, and an outlet portion extending from an entrance aperture in the target surface to an exit aperture from which the liquid product emerges as a spray, the target surface having at least one channel formed therein that causes a turbulent flow of the liquid product, in use, into the outlet portion of the dispensing conduit.

The dispensing apparatus according to the invention is advantageous principally because turbulent flow is formed in the liquid product, in use, without the need for a flow-modifying insert, or any other additional component. The dispensing apparatus may therefore comprise an actuator that is formed as a single component, thereby reducing manufacturing costs for such dispensing apparatus considerably. In addition, the provision of a target surface with which the liquid product collides, in use, increases the degree of atomisation achieved by the apparatus according to the invention, and also facilitates construction of an actuator that is injection moulded as a single component.

By “turbulent flow” is meant flow accompanied by sufficient forces to cause atomisation of the liquid product as it traverses, and exits from, the outlet portion of the dispensing conduit. Most preferably, the turbulent flow has the general form of a vortex, ie flow of the liquid product along and around the longitudinal axis of the outlet portion of the dispensing conduit.

The entire target surface is preferably exposed to the liquid product flowing, in use, along the inlet portion of the dispensing conduit, such that the liquid product collides with the entire target surface. The target surface is preferably orientated substantially in a plane, and is most preferably orientated such that the normal of the target surface is orientated at an angle of less than 90° to the direction of flow of the liquid product along the inlet portion of the dispensing conduit. Most preferably, the normal of the target surface is orientated at an angle of less than 60° to the direction of flow of the liquid product along the inlet portion of the dispensing conduit.

The inlet portion of the dispensing conduit is preferably tubular in form, and is most preferably generally cylindrical. The longitudinal axis of the inlet portion is therefore preferably coincidental with the direction of flow of the liquid product along the inlet portion during use. The target surface is preferably circular, or elliptical, in shape, and preferably forms an end wall for the inlet portion.

The outlet portion of the dispensing conduit is preferably tubular in form, and is most preferably generally cylindrical. The entrance aperture is preferably circular, or elliptical, in shape. The inlet and outlet portions of the dispensing conduit may be orientated at an angle to one another. For example, the inlet and outlet portions may be orientated generally perpendicular to each other. The length of the outlet portion is selected depending upon the desired spray characteristics, and the outlet portion may include an end portion of gradually increasing cross-sectional dimensions that leads to an exit aperture of increased cross-sectional area relative to the entrance aperture.

The target surface preferably has a plurality of channels formed therein, and most preferably three or more channels, the number and form of the channels being selected depending upon the desired spray characteristics. Each channel may be formed as a recess in the target surface, or may be formed between formations that are embossed on the target surface.

The one or more channels are preferably adapted to form a vortex within the liquid product. In one possible configuration, each channel guides the liquid product transversely to the longitudinal axis of the outlet portion and into a portion of the entrance aperture that is offset from its centre, thereby forming a vortex within the liquid product as it flows into the entrance aperture. In this case, each channel preferably extends from the peripheral edge of the target surface to the entrance aperture, and each channel is preferably tapered as it extends towards the entrance aperture.

In another possible configuration, each channel guides the liquid product transversely to the longitudinal axis of the outlet portion so as to form a vortex within the liquid product before the liquid product flows into the entrance aperture. In this case, the target surface preferably includes a generally circular recess surrounding the entrance aperture, and each channel preferably guides the liquid product into a portion of the circular recess that is offset from its centre.

In any case, where the target surface has a plurality of channels formed therein, all the channels preferably guide the liquid product transversely to the longitudinal axis of the outlet portion such that liquid product emerging from each channel flows in the same rotational direction about the longitudinal axis of the outlet portion.

The dispensing conduit preferably forms part of an actuator for actuating a dispensing valve of a container that stores the liquid product. The dispensing apparatus therefore preferably comprises a container for storing the liquid product, a dispensing valve having a valve outlet through which the liquid product is released under pressure, when actuated, and the actuator which is engaged with the dispensing valve such that the inlet portion of the dispensing conduit is in communication with the valve outlet.

The container and dispensing valve may together have the form of a conventional aerosol canister in which the liquid product is stored under pressure. Alternatively, the dispensing valve may include pump means for urging the liquid product though the dispensing valve under pressure. In any case, however, the dispensing valve is usually actuated by depressing the valve outlet of the dispensing valve. The actuator component therefore preferably includes a recess for receiving an upper end of the valve outlet with a close fit, the recess being in communication with the inlet portion of the dispensing conduit.

The present invention removes the need for a separate flow-modifying insert to form a vortex in the liquid product emerging from the exit aperture. The actuator component is therefore preferably formed as a single component, preferably by injection moulding of plastics material.

The invention will now be described in greater detail, by way of illustration only, with reference to the accompanying drawings, in which

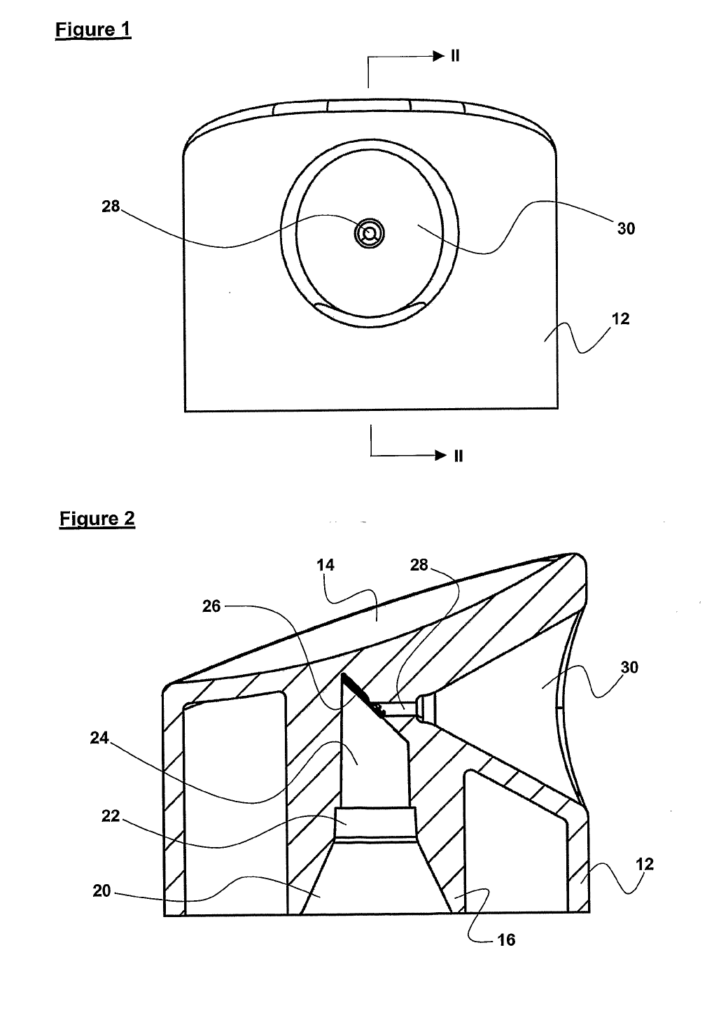

FIG. 1 is a front view of a first embodiment of an actuator cap according to the invention;

FIG. 2 is a cross-sectional view of the first embodiment along the line II-II in FIG. 1;

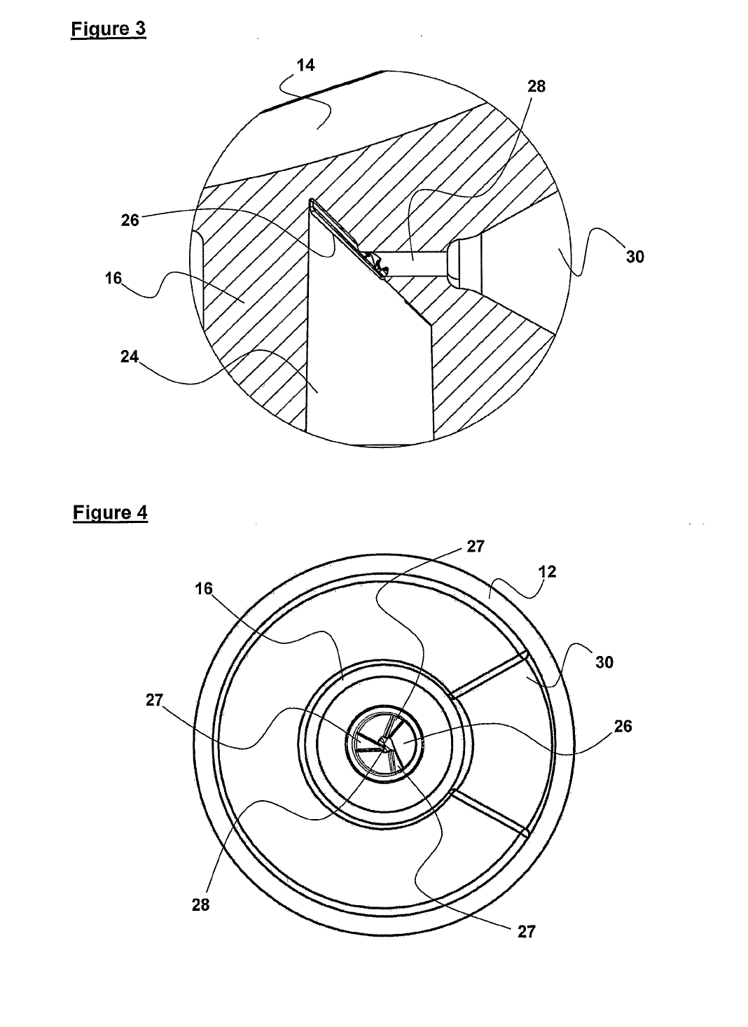

FIG. 3 is a cross-sectional view of part of the first embodiment;

FIG. 4 is an underside view of the first embodiment;

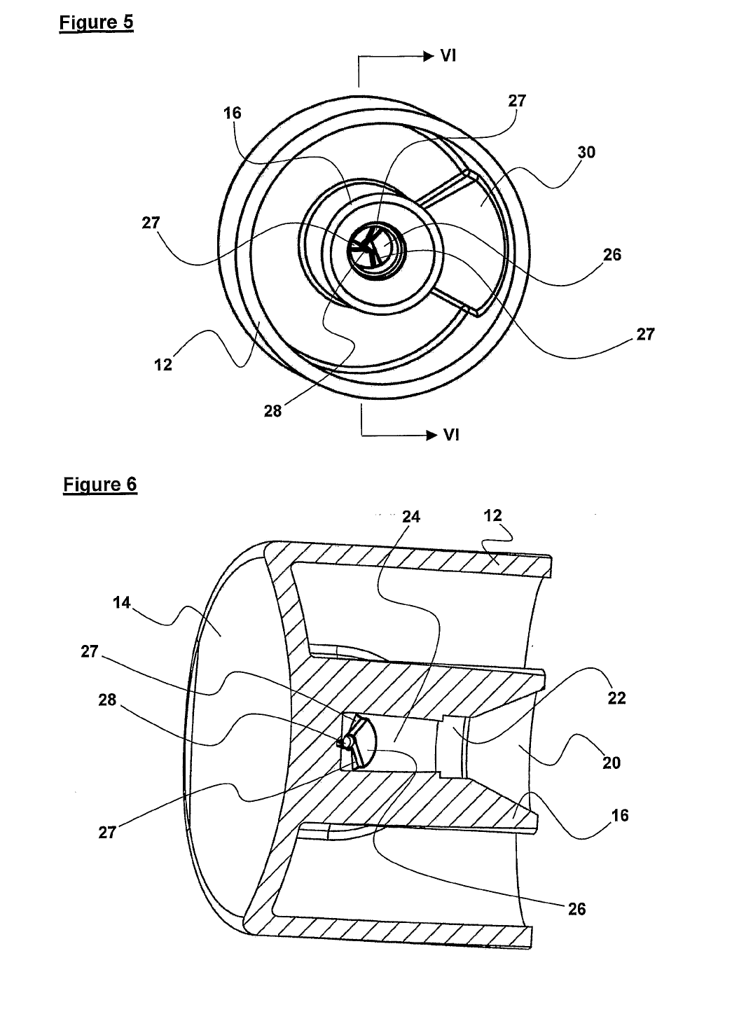

FIG. 5 is a perspective view of the underside of the first embodiment;

FIG. 6 is a cross-sectional view of the first embodiment along the line VI-VI in FIG. 5;

FIG. 7 is a perspective view of a second embodiment of an actuator cap according to the invention;

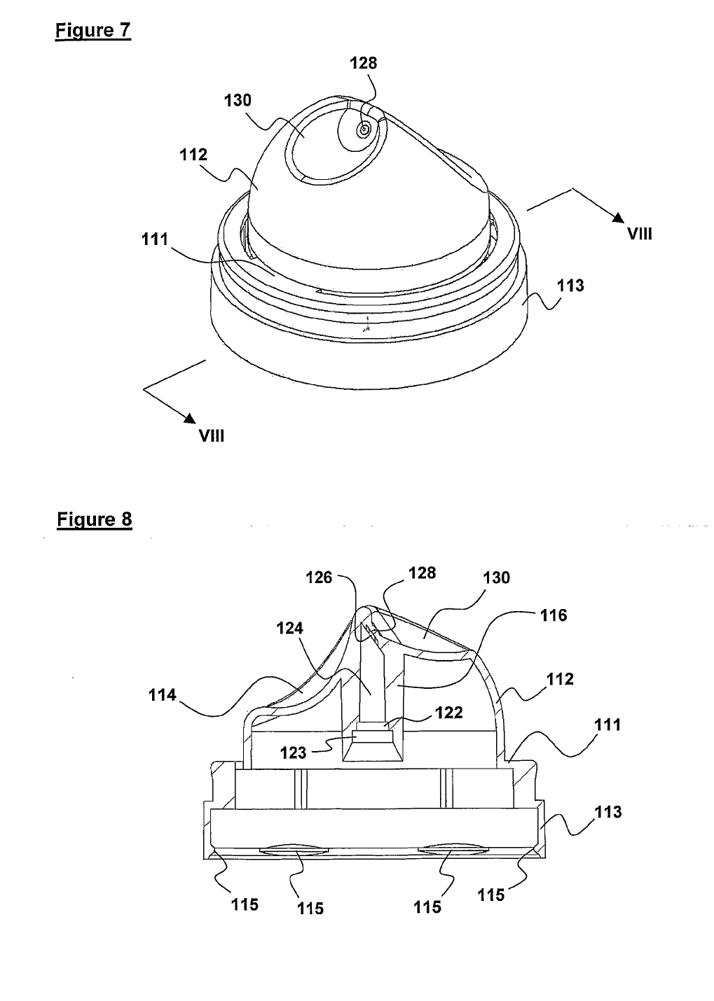

FIG. 8 is a cross-sectional view of the second embodiment along the line VIII-VIII in FIG. 7;

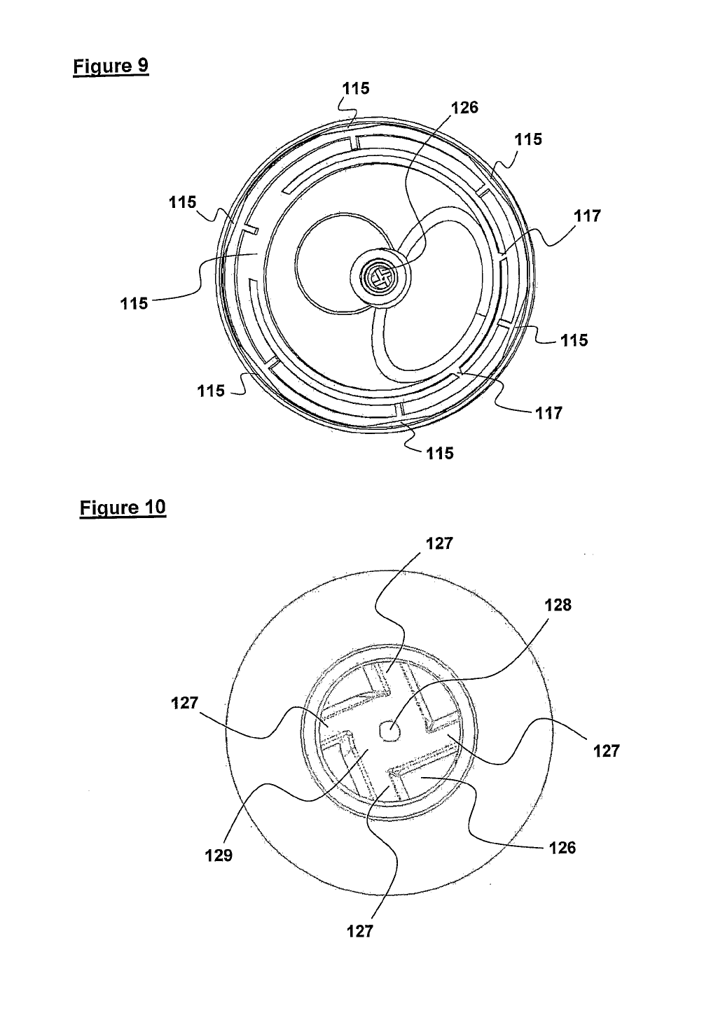

FIG. 9 is a perspective view of the underside of the second embodiment; and

FIG. 10 is a close-up view of a target surface of the second embodiment.

FIGS. 1 to 6 show a first embodiment of an actuator cap according to the invention. The actuator cap is formed as a single component of plastics material by injection moulding. The actuator cap is adapted to engage an aerosol canister (not shown in the Figures) comprising a sealed container that stores a liquid product under pressure, and a dispensing valve that, when actuated, allows the liquid product to exit the container through the valve. The actuator cap described below provides means for actuating the dispensing valve and forming a spray of liquid.

The aerosol canister with which the actuator cap is intended for use comprises a dispensing valve having a tubular valve stem extending upwardly from an upper surface of the aerosol canister. The dispensing valve is such that depression of the valve stem will cause the liquid product to flow, under pressure, out of the canister through the valve stem.

As shown most clearly in FIG. 2, the actuator cap has an outer wall 12 that is generally cylindrical in shape, with an open base and an upper wall forming a closed upper end. The upper wall of the actuator cap is inclined relative to the base such that the actuator cap is of greater height at a front end than at a diametrically-opposed rear end. The upper surface 14 of the actuator cap is concave in form, thereby providing a surface suitable for a user to impart a downward force (as viewed in FIGS. 1 and 2) on the actuator cap, in use, to depress the valve stem, as described in more detail below.

A central stem 16, with a cylindrical exterior surface, extends co-axially with the outer wall 12 from the upper wall to the base of the actuator cap. The interior of the central stem 16 defines a passageway that extends from the base of the actuator cap to a position adjacent to the upper wall. The passageway comprises a funnel portion 20 (as viewed in FIG. 2) of gradually reducing width, the funnel portion 20 leading into a cylindrical receiving portion 22 adapted to receive the upper end of the valve stem with a close fit, and the cylindrical receiving portion 22 leading into a generally cylindrical chamber 24 of reduced diameter. A shoulder is formed between the cylindrical receiving portion 22 and the chamber 24 of reduced diameter such that the upper end of the valve stem abuts this shoulder when engaged with the actuator cap.

The chamber 24 terminates at its upstream end with a target surface 26. The target surface 26 is orientated at an angle of 45° to the longitudinal axis of the chamber 24 and hence, in use, to the direction of liquid flow. A cylindrical outlet conduit 28 extends from a circular aperture in the target surface 26 towards the front of the actuator cap. The outlet conduit 28 is orientated such that its longitudinal axis is perpendicular to the longitudinal axis of the channel 24, and hence at 45° to the target surface 26. At its downstream end, the outlet conduit 28 leads into an exit passageway 30 of gradually increasing cross-sectional area, which extends between the central stem 16 of the actuator cap and a large circular outlet aperture formed in the outer wall 12.

As shown most clearly in FIGS. 4, 5 and 6, the target surface 26 has three channels 27 formed therein. These channels 27 extend from equiangularly spaced positions at the peripheral edge of the target surface 26, and are tapered to a portion of the circular aperture that is offset from its centre. In order to form a vortex within the liquid product flowing through the actuator cap, in use, all the channels 27 guide the liquid product into the entrance aperture in the same rotational direction relative to the longitudinal axis of the outlet conduit 28, as shown most clearly in FIG. 4.

The actuator cap described above is fitted to the aerosol canister by inserting the upper end of the valve stem, with a close fit, into the cylindrical receiving portion 22 of the central stem 16. When the actuator cap and aerosol canister are engaged with one another, the upper end of the valve stem abuts the shoulder formed between the cylindrical receiving portion 22 and the chamber 24 of the main stem 16.

When a user wishes to dispense the liquid product, the user urges the actuator cap towards the aerosol canister, thereby depressing the valve stem. This action causes the liquid product to flow, under pressure, through the valve stem and into the chamber 24 of the actuator cap. The liquid product will then strike the target surface 26 and flow along the channels 27 into the outlet conduit 28. A vortex will be formed in the liquid product that flows along the outlet conduit 28, as discussed above. The liquid product will then be emitted as a spray into the interior of the exit passageway 30, and the spray will exit the actuator cap through the large circular outlet aperture formed in the outer wall 12.

Striking of the liquid on the target surface 26, and the vortex within the liquid product that flows along the outlet conduit 28, will both act to atomise the liquid product such that the spray will have the form of a fine mist of liquid droplets. Many different parts of the actuator cap may be varied so as to alter the characteristics of the spray formed. For example, the number of channels 27, the length of the outlet conduit 28, and the orientation of the target surface 26 relative to the direction of liquid flow, may all be varied to alter the characteristics of the spray formed.

FIGS. 7 to 10 show a second embodiment of an actuator cap according to the invention. The second embodiment is of similar construction to the first embodiment, but there are some differences which are described below.

The second embodiment comprises an operable portion 112 that is similar in form to the actuator cap of the first embodiment, and a base portion 113 for mounting the actuator cap to an aerosol canister. The upper surface of the operable portion 112 comprises a front concave portion 130 into which the outlet conduit 128 opens and hence from which the spray is emitted, and a rear concave portion 114 that a user depresses, in use. The central stem 116 of the operable portion 112 is similar to that of the first embodiment save for the provision of upper and lower receiving portions 122,123 having different diameters. This enables the operable portion 112 of the second embodiment to engage valve stems having a greater range of diameters than is possible with the first embodiment.

The base portion 113 is generally annular in shape, and includes projections 115 at the lower end of its interior surface that enable it to engage a peripheral rim of the aerosol canister with a snap fit. The operable portion 112 is mounted within the upper opening defined by the base portion 113, and is attached to the base portion 113 at its front end, ie the end towards which the spray is directed, by a neck 111 and at its rear end by a pair of shearable webs 117.

FIGS. 9 and 10 show the target surface 126 of the second embodiment. The target surface 126 comprises a generally circular recess 129 that surrounds a central, outlet conduit 128. The target surface 126 further comprises four channels 127, each channel 127 extending from the periphery of the target surface 126 into an outer portion of the circular recess 129. Each channel 127 is orientated perpendicularly to its adjacent channels 127, and guides the liquid product into the circular recess 129 generally perpendicularly to the radius of the circular recess 129. All the channels 127 guide the liquid product into the circular recess 129 in the same rotational direction relative to the longitudinal axis of the outlet conduit 128 so that, in use, a vortex forms in the liquid product flowing through the circular recess 129 and into the outlet conduit 128. As shown in FIG. 8, the outlet conduit 128 is orientated perpendicularly to the target surface 126, and hence at an angle of approximately 45° to the longitudinal axis of the central stem 116.

The target surface 126 of the second embodiment differs from the target surface 26 of the first embodiment principally in that a vortex is formed in the liquid product before the liquid product enters the outlet conduit 128, rather than whilst the liquid product is entering the outlet conduit 128.

When the actuator cap is used for the first time, the user will depress the rear concave portion 114 of the operable portion 112, thereby causing the shearable webs 117 to detach from the base portion 113 and the operable portion 112 to pivot downwards about the neck 111. On subsequent uses, depressing the rear concave portion 114 of the operable portion 112 will simply causing the operable portion 112 to pivot downwards about the neck 111.

Pivoting of the operable portion 112 downwards about the neck 111 will cause the valve stem that is engaged with the upper or lower receiving portion 122,123 to become depressed. The liquid product will then flow, under pressure, through the valve stem and into the chamber 124 of the actuator cap. The liquid product will collide with the target surface 126 and then flow along the channels 127 into the circular recess 129. A vortex will be formed in the liquid product, which then flows into the outlet conduit 128, as discussed above. The liquid product will finally be emitted as a spray through the front concave portion 130 of the upper surface of the operable portion 112.

1-25. (canceled)

26. Apparatus for dispensing a liquid product in the form of a spray, said apparatus comprising a dispensing conduit having an inlet portion terminating at a target surface with which, in use, the liquid product collides, and an outlet portion extending from an entrance aperture in the target surface to an exit aperture from which the liquid product emerges as a spray, the target surface having at least one channel formed therein that causes a turbulent flow of the liquid product, in use, into the entrance aperture in the target surface and hence into the outlet portion of the dispensing conduit.

27. Apparatus as claimed in claim 26, wherein the turbulent flow has the general form of a vortex, whereby the liquid product flows along and around a longitudinal axis of the outlet portion of the dispensing conduit.

28. Apparatus as claimed in claim 26, wherein the entire target surface is exposed to the liquid product flowing, in use, along the inlet portion of the dispensing conduit, such that the liquid product collides with the entire target surface.

29. Apparatus as claimed in claim 26, wherein the target surface is orientated substantially in a plane.

30. Apparatus as claimed in claim 29, wherein the normal of the target surface is orientated at an angle of less than 90° to the direction of flow of the liquid product along the inlet portion of the dispensing conduit.

31. Apparatus as claimed in claim 29, wherein the normal of the target surface is orientated at an angle of less than 60° to the direction of flow of the liquid product along the inlet portion of the dispensing conduit

32. Apparatus as claimed in claim 26, wherein the target surface is circular or elliptical in shape.

33. Apparatus as claimed in claim 26, wherein the target surface has a plurality of channels formed therein.

34. Apparatus as claimed in claim 33, wherein the target surface has three or more channels formed therein.

35. Apparatus as claimed in claim 26, wherein each channel is formed as a recess in the target surface.

36. Apparatus as claimed in claim 26, wherein each channel is formed between formations that are embossed on the target surface.

37. Apparatus as claimed in claim 26, wherein the one or more channels are adapted to form a vortex within the liquid product.

38. Apparatus as claimed in claim 37, wherein each channel guides the liquid product transversely to a longitudinal axis of the outlet portion and into a portion of the entrance aperture that is offset from its centre, thereby forming a vortex within the liquid product as it flows into the entrance aperture.

39. Apparatus as claimed in claim 38, wherein each channel extends from the peripheral edge of the target surface to the entrance aperture.

40. Apparatus as claimed in claim 39, wherein each channel is tapered as it extends towards the entrance aperture.

41. Apparatus as claimed in claim 37, wherein each channel guides the liquid product transversely to the longitudinal axis of the outlet portion so as to form a vortex within the liquid product before the liquid product flows into the entrance aperture.

42. Apparatus as claimed in claim 41, wherein the target surface includes a generally circular recess surrounding the entrance aperture, and each channel guides the liquid product into a portion of the circular recess that is offset from its center.

43. Apparatus as claimed in claim 37, wherein the target surface has a plurality of channels formed therein, all the channels guiding the liquid product transversely to a longitudinal axis of the outlet portion such that liquid product emerging from each channel flows in the same rotational direction about the longitudinal axis of the outlet portion.

44. Apparatus as claimed in claim 26, wherein the dispensing conduit forms part of an actuator for actuating a dispensing valve of a container that stores the liquid product.

45. Apparatus as claimed in claim 44, wherein the dispensing apparatus comprises a container for storing the liquid product, a dispensing valve having a valve outlet through which the liquid product is released under pressure, when actuated, and the actuator which is engaged with the dispensing valve such that the inlet portion of the dispensing conduit is in communication with the valve outlet.

46. Apparatus as claimed in claim 45, wherein the container and dispensing valve together have the form of a conventional aerosol canister in which the liquid product is stored under pressure.

47. Apparatus as claimed in claim 45, wherein the dispensing valve includes pump means for urging the liquid product through the dispensing valve under pressure.

48. Apparatus as claimed in claim 45, wherein the dispensing valve is actuated by depressing the valve outlet of the dispensing valve.

49. Apparatus as claimed in claim 48, wherein the actuator includes a recess for receiving an upper end of the valve outlet with a close fit, the recess being in communication with the inlet portion of the dispensing conduit.

50. Apparatus as claimed in claim 44, wherein the actuator is formed as a single component by injection molding of plastics material.

51. Apparatus for dispensing a liquid product in the form of a spray, said apparatus comprising an actuator that is formed as a single plastics component by injection molding, said actuator comprising a dispensing conduit having an inlet portion terminating at a target surface, and an outlet portion extending from an entrance aperture in the target surface to an exit aperture from which the liquid product emerges as a spray, the entire target surface being exposed to the liquid product flowing, in use, along the inlet portion of the dispensing conduit, such that the liquid product collides with the entire target surface, and the target surface having at least one channel formed therein that causes a turbulent flow of the liquid product, in use, into the outlet portion of the dispensing conduit, wherein each channel is either formed as a recess in the target surface or formed between formations that are embossed on the target surface.
